(19) United States
(12) Patent Application Publication
(10) Pub. No.: US 2024/0267932 A1
(43) Pub. Date: Aug. 8, 2024

(54) PDCCH MONITORING ADAPTATION FOR OPERATION IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/417,966

(22) Filed: Jan. 19, 2024

Related U.S. Application Data
(60) Provisional application No. 63/443,299, filed on Feb. 3, 2023.

(51) Int. Cl. H04W 72/232; H04L 5/14; H04W 72/0446

(52) U.S. Cl. CPC H04W 72/232; H04L 5/14; H04W 72/0446

(57) ABSTRACT

Methods and apparatuses for physical downlink control channel (PDCCH) monitoring adaptation. A method for a user equipment (UE) includes receiving first and second sets of parameters for reception of first and second PDCCHs associated with first and second subsets of slots, respectively, on a cell and receiving a first PDCCH from the first PDCCHs that provides a downlink control information (DCI) format. The DCI format indicates skipping receptions of the second PDCCHs for a time duration. The method further includes skipping, based on the field, receptions of the second PDCCHs at a first occasion that is after reception of the first PDCCH and before an end of the time duration. The second subset of slots includes resources indicated for simultaneous transmission and reception and the first subset of slots does not.

### CROSS-REFERENCE TO RELATED AND CLAIM OF PRIORITY

The present application claims priority under 35 U.S.C. § 119(e) to: U.S. Provisional Patent Application No. 63/443,299 filed on Feb. 3, 2023, which is hereby incorporated by reference in its entirety.

### TECHNICAL FIELD

The present disclosure relates generally to wireless communication systems and, more specifically, the present disclosure is related to apparatuses and methods for physical downlink control channel (PDCCH) monitoring adaptation for operation in full-duplex (FD) systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to PDCCH monitoring adaptation for operation in FD systems.

In one embodiment, a method for a user equipment (UE) to receive physical downlink control channels (PDCCHs) is provided. The method includes receiving a first set of parameters for reception of first PDCCHs associated with a first subset of slots from a set of slots on a cell, receiving a second set of parameters for reception of second PDCCHs associated with a second subset of slots from the set of slots on the cell, and receiving a first PDCCH from the first PDCCHs that provides a downlink control information (DCI) format. The method further includes skipping, based on the field, receptions of the second PDCCHs in a slot from the second subset of slots at a first occasion that is after reception of the first PDCCH and before an end of the time duration. The first subset of slots does not include time-domain resources indicated for simultaneous transmission and reception on the cell. The second subset of slots includes time-domain resources indicated for simultaneous transmission and reception on the cell.

In another embodiment, a user equipment (UE) is provided. The UE includes a processor and a transceiver operably coupled to the processor. The transceiver is configured to receive a first set of parameters for reception of first PDCCHs associated with a first subset of slots from a set of slots on a cell, receive a second set of parameters for reception of second PDCCHs associated with a second subset of slots from the set of slots on the cell, and receive a first PDCCH from the first PDCCHs that provides a DCI format. The transceiver is further configured to skip, based on the field, receptions of the second PDCCHs in a slot from the second subset of slots at a first occasion that is after reception of the first PDCCH and before an end of the time duration. The first subset of slots does not include time-domain resources indicated for simultaneous transmission and reception on the cell. The second subset of slots includes time-domain resources indicated for simultaneous transmission and reception on the cell.

In yet another embodiment, a base station (BS) is provided. The BS includes a processor and a transceiver operably coupled to the processor. The transceiver is configured to transmit a first set of parameters for reception of first PDCCHs associated with a first subset of slots from a set of slots on a cell, transmit a second set of parameters for reception of second PDCCHs associated with a second subset of slots from the set of slots on the cell, and transmit a first PDCCH from the first PDCCHs that provides a DCI format. The transceiver is further configured to transmit the second PDCCHs in a slot from the second subset of slots at a first occasion, receptions of which is skipped, that is after transmission of the first PDCCH and before an end of the time duration. The first subset of slots does not include time-domain resources indicated for simultaneous transmission and reception on the cell. The second subset of slots includes time-domain resources indicated for simultaneous transmission and reception on the cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIG. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a timeline of an example time division duplex (TDD) configuration according to embodiments of the present disclosure;

FIG. 7 illustrates timelines of example FD configurations according to embodiments of the present disclosure;

FIG. 8 illustrates a timeline for PDCCH skipping according to embodiments of the disclosure;

FIG. 9 illustrates a flowchart of an example UE procedure for PDCCH skipping according to embodiments of the present disclosure;

FIG. 10 illustrates a timeline for search space set group (SSSG) switching according to embodiments of the disclosure;

FIG. 11 illustrates a flowchart of an example UE procedure for SSSG switching according to embodiments of the present disclosure; and

FIG. 12 illustrates a timeline of a DCI indication for PDCCH monitoring adaptation according to embodiments of the present disclosure.

### DETAILED DESCRIPTION

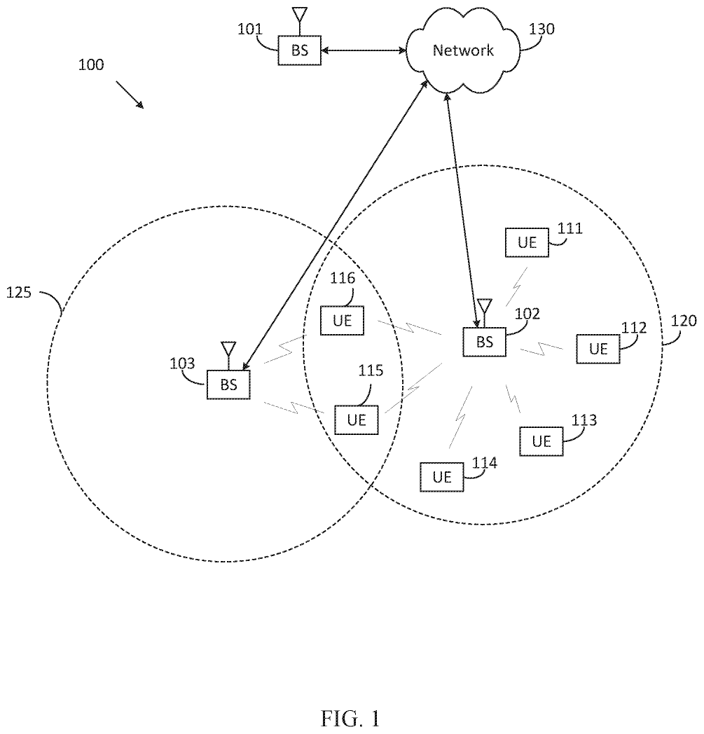

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents are hereby incorporated by reference into the present disclosure as if fully set forth herein: 3GPP TS 38.211 v17.4.0, “NR; Physical channels and modulation” (REF1); 3GPP TS 38.212 v17.4.0, “NR; Multiplexing and Channel coding” (REF2); 3GPP TS 38.213 v17.4.0, “NR; Physical Layer Procedures for Control” (REF3); 3GPP TS 38.214 v17.4.0, “NR; Physical Layer Procedures for Data” (REF4); 3GPP TS 38.321 v17.3.0, “NR; Medium Access Control (MAC) protocol specification” (REF5); 3GPP TS 38.331 v17.3.0, “NR; Radio Resource Control (RRC) Protocol Specification” (REF6); 3GPP TS 38.306 v17.3.0, “NR; User Equipment (UE) radio access capabilities” (REF7); and 3GPP TS 38.133 v17.8.0, “NR; Requirements for support of radio resource management” (REF8).

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for PDCCH monitoring adaptation for operation in FD systems. In certain embodiments, one or more of the BSs 101-103 include circuitry, programing, or a combination thereof to support PDCCH monitoring adaptation for operation in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

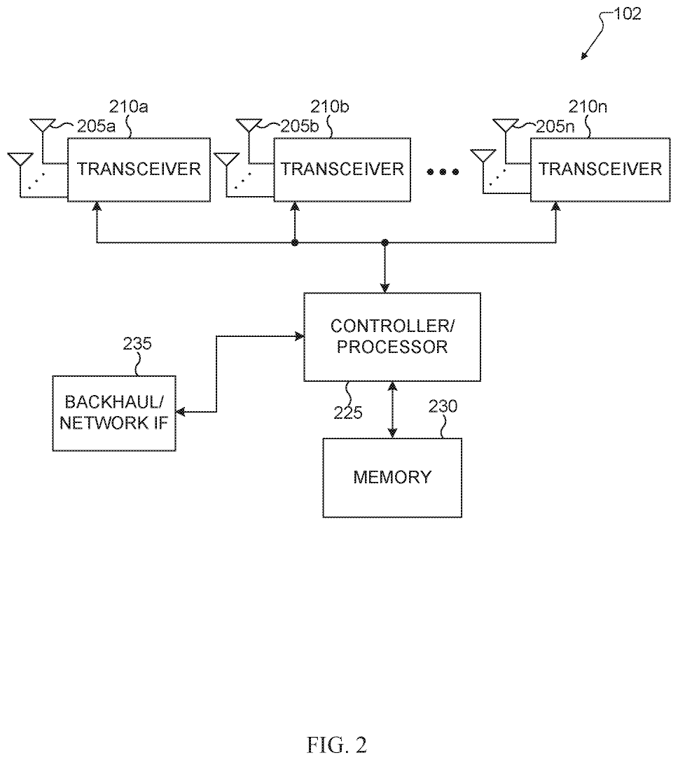

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals.

The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles.

The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for PDCCH monitoring adaptation for operation in FD systems as described in greater detail below. Any of a wide variety of other functions could be supported in the gNB 102 by the controller/processor 225. The controller/processor 225 can move data into or out of the memory 230 as required by an executing process.

The controller/processor 225 is also capable of executing programs and other processes resident in the memory 230, such as processes to support PDCCH monitoring adaptation for operation in FD systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

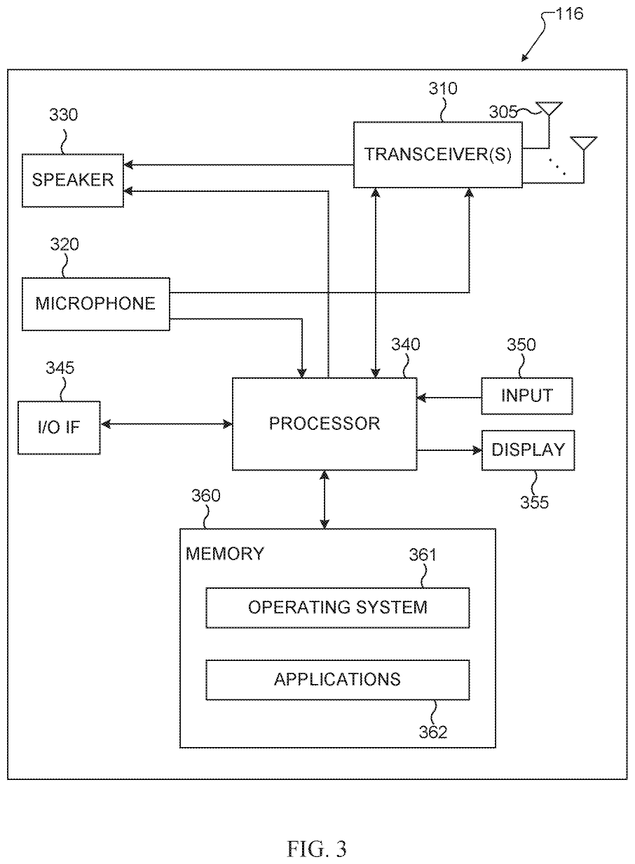

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for PDCCH monitoring adaptation for operation in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

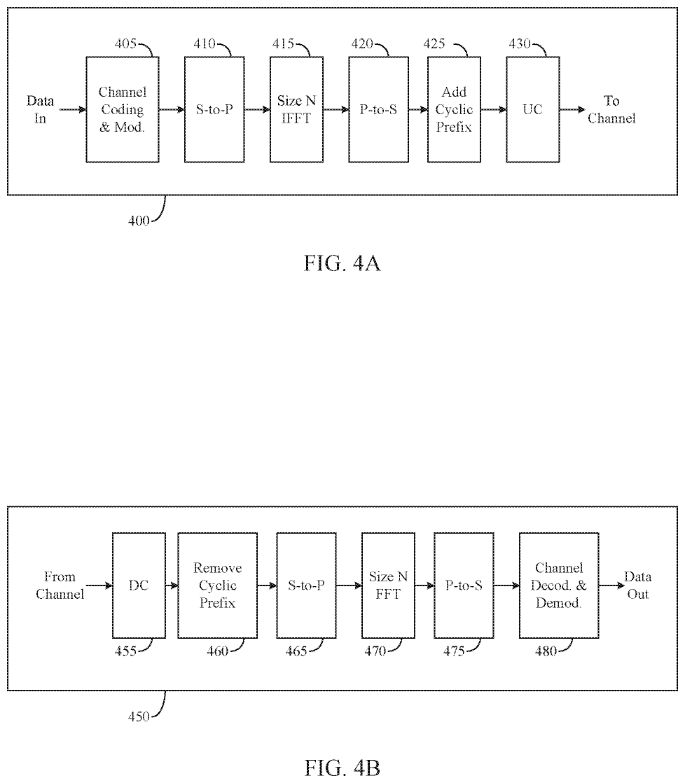

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive information for PDCCH monitoring adaptation for operation in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channels (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co located (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a medium access control (MAC)-control element (CE) activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3N^{subframe,μ}ₛₗₒₜ). slot

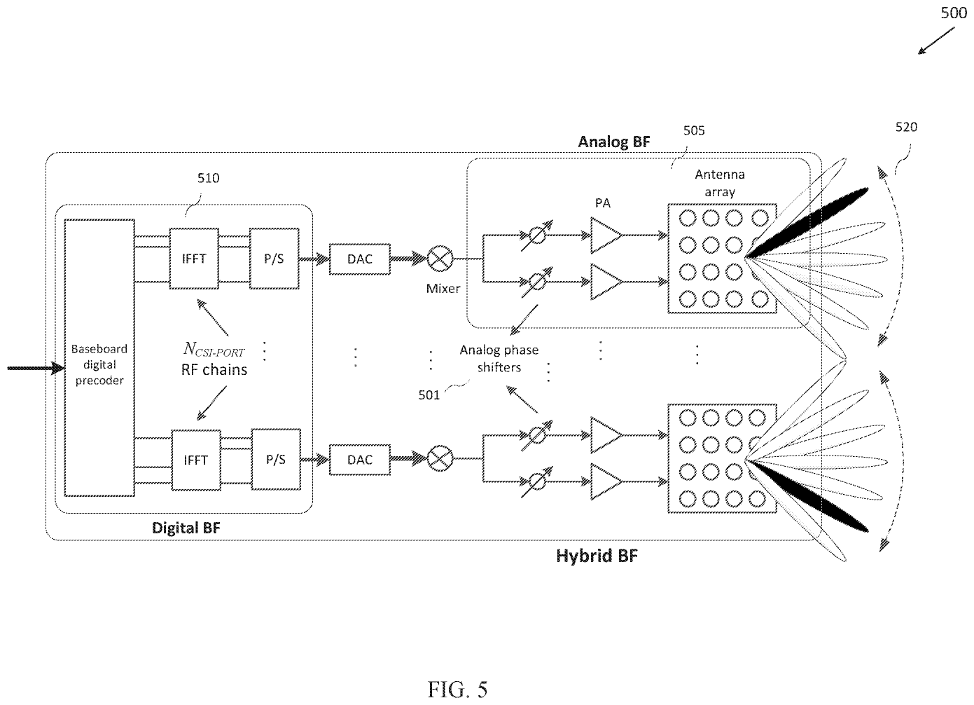

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N _{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 2-2 or FR2-2). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

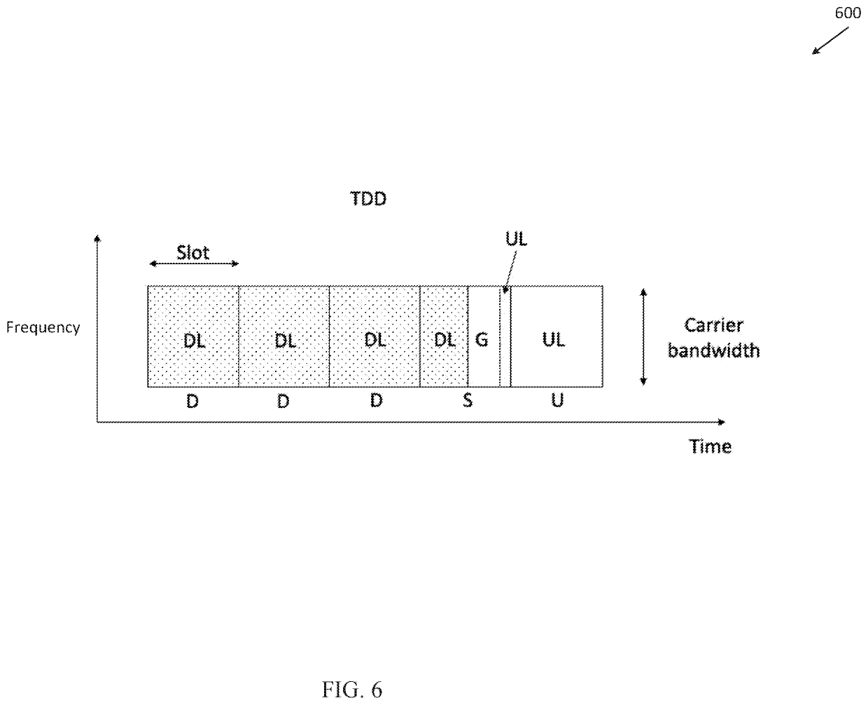

FIG. 6 illustrates a timeline 600 of an example TDD configuration. For example, timeline 600 of an example TDD configuration can be utilized by the BS 102 of FIG. 1 and the UE 116 of FIG. 3. This example is for illustration only and other embodiments can be used without departing from the scope of the present disclosure.

With reference to FIG. 6, A DDDSU UL-DL configuration is shown. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL evaluating an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a physical uplink control channel (PUCCH) providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a downlink control information (DCI) format is supported. With the exception of some symbols in some slots supporting predetermined transmissions, such as for synchronization signal blocks (SSBs), symbols of a slot or in a subband can have a flexible direction (UL or DL) that a UE can determine according to scheduling information for transmissions or receptions. A physical downlink control channel (PDCCH) can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross link interference (CLI) where, for example, DL receptions in a cell by a UE can experience large interference from UL transmissions in the same or neighboring cells from other UEs.

FD communications offer a potential for increased spectral efficiency, improved capacity, and reduced latency in wireless networks. When using FD communications, a gNB or a UE simultaneously receives and transmits on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as subband-full-duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE 116 occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present disclosure recognize full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel

CLI because in several cellular band allocations, different operators have adjacent spectrum.

Throughout the present disclosure, the term Full-Duplex (FD) is used as a short form for a full-duplex operation in a wireless system. The terms Cross-Division-Duplex (XDD) and FD may be used interchangeably in the present disclosure.

FD operation in NR can improve spectral efficiency, link robustness, capacity, and latency of UL transmissions. In an NR TDD system, transmissions from a UE are limited by fewer available transmission opportunities than receptions by the UE 116. For example, for NR TDD with subcarrier spacing (SCS)=30 kHz, DDDU (2 msec), DDDSU (2.5 msec), or DDDDDDDSUU (5 msec), the UL-DL configurations allow for an DL: UL ratio from 3:1 to 4:1. Any transmission from the UE 116 can only occur in a limited number of UL slots, for example every 2, 2.5, or 5 msec, respectively.

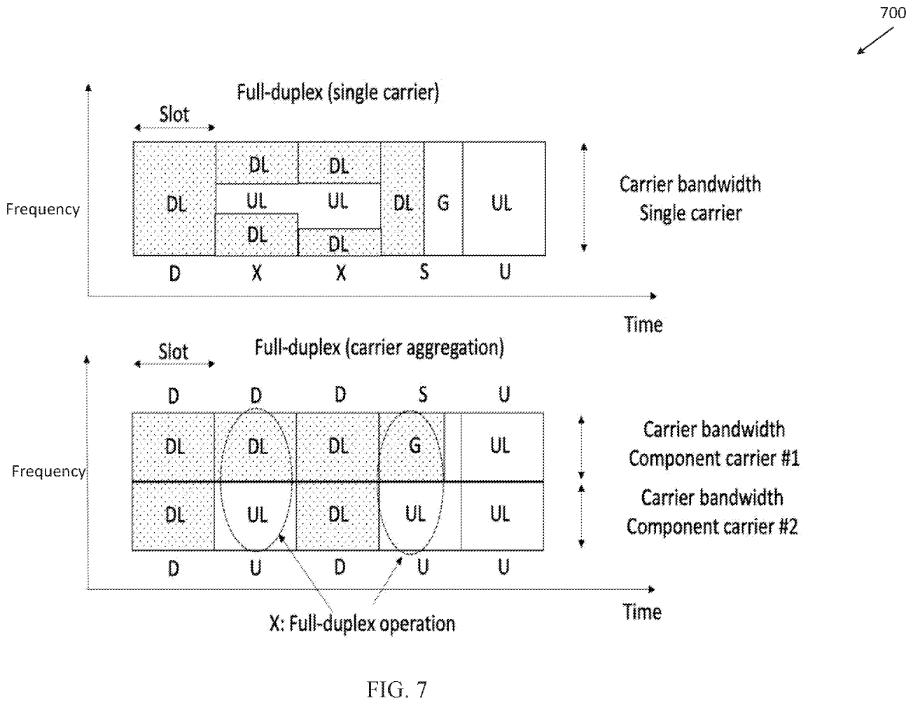

FIG. 7 illustrates timelines 700 of example FD configurations according to embodiments of the present disclosure. For example, timelines 700 can be utilized by the BS 102 of FIG. 1 and the UE 116 of FIG. 3. This example is for illustration only and other embodiments can be used without departing from the scope of the present disclosure.

For a single carrier TDD configuration with FD enabled, slots denoted as X are FD slots. Both DL and UL transmissions can be scheduled in FD slots for at least one or more symbols.

The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB 102/UE 116, and S slots that are used for both transmission and receptions by the gNB 102/UE 116 and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period or can be indicated by higher layer signaling, such as via a MAC CE or RRC.

For a UE in RRC_CONNECTED mode, PDCCH monitoring activity of the UE 116 may be controlled in several ways by a serving gNB using higher layer signaling through bandwidth part (BWP) adaptation, or discontinuous reception (DRX) as described in REF3, REF5 and REF6. The PDCCH monitoring activity of the UE 116 can be further controlled by the Rel-16 NR feature for UE power savings using DCI format 2_6 with CRC scrambled by PS-RNTI (DCP) and by Rel-17 NR PDCCH adaptation features such as PDCCH skipping and search space set group (SSSG) switching as described in REF3.

Using Rel-15 NR and when a gNB configures BWP adaptation to a UE, the gNB 102 may set transmission and reception bandwidths for the UE 116 to be smaller than the NR carrier bandwidth. Up to 4 DL or UL BWPs may be configured for a UE. For operation in unpaired spectrum, i.e., TDD, a DL BWP and UL BWP in a DL/UL BWP pair have a same center frequency.

A UE has only one active DL BWP for receptions and only one active UL BWP for transmissions at any given time. A UE monitors PDCCH on the one active DL BWP i.e., the UE 116 does not have to monitor PDCCH on the entire DL frequency of the cell or on configured DL BWPs that are not active. A BWP inactivity timer (independent from the DRX inactivity timer) may be used for a UE to switch an active DL BWP to a default DL BWP when multiple DL BWPs are available for the UE 116. The UE 116 restarts the BWP inactivity timer upon successful decoding of a DCI format and the change to the default DL BWP occurs when the timer expires as described in REF3.

Using Rel-15 NR and when a UE operates with DRX, the UE 116 is not required to continuously monitor the PDCCH on the active BWP. DRX operation in RRC_CONNECTED mode (C-DRX) is based on the use of a configurable DRX cycle for the UE 116. When a DRX cycle is configured, the UE 116 monitors PDCCH only during the active time. The UE 116 does not need to monitor PDCCH and can switch off receiver circuitry during certain periods of the inactivity time. That operation reduces UE power consumption. The longer the DRX inactive time, the lower the UE 116 power consumption but the larger the latency for scheduling the UE 116 as the gNB scheduler can only reach the UE 116 when the UE 116 is active according to its DRX cycle. Typically, if the UE 116 has been scheduled and is receiving or transmitting data, the UE 116 is likely to be frequently scheduled and waiting until the next activity period according to the DRX cycle would result in additional delays. Therefore, to reduce or avoid such delays, the UE 116 remains in the active state for a configurable time period after being scheduled. That is realized by a DRX inactivity timer that the UE 116 starts every time the UE 116 is scheduled, and the UE 116 remains awake until the timer expires.

Rel-16 NR provides additional features to reduce UE power consumption for UE in RRC_CONNECTED mode such as DCI with CRC scrambled by PS-RNTI (DCP), cross-slot scheduling, or MIMO layer adaptation features. The UE 116 may provide assistance information to the gNB 102 to indicate its preferred radio or protocol configurations, such as its preferred C-DRX configuration, aggregated bandwidth, SCell configuration, MIMO configuration, configuration parameters for an RRC state, or minimum scheduling offset values, for a gNB or network to select a UE radio or UE protocol configuration.

Using Rel-16 NR, when a UE is configured to monitor PDCCH associated with a DCI format 2_6 with CRC scrambled by PS-RNTI (DCP), the UE 116 may be indicated by the DCP whether or not the UE 116 is required to monitor PDCCH on the PCell during a next occurrence of the on-duration of the UE 116's C-DRX cycle. If the UE 116 does not detect a DCP on the active BWP prior to a next on-duration, the UE 116 does not monitor PDCCH during the next on-duration unless the UE 116 is explicitly indicated by the gNB 102 via prior higher signaling to monitor PDCCH in that case. The DCP feature using DCI format 2_6 may also provide SCell dormancy indication in case the UE 116 has activated SCells. A UE can only be configured to monitor DCP when DRX in RRC_CONNECTED mode (C-DRX) is configured and at one or more monitoring occasions located at configured offsets before the DRX on-duration. The UE 116 does not monitor DCP on occasions occurring during active time, measurement gaps, BWP switching, or when the UE 116 monitors response for a contention free random access (CFRA) preamble transmission for beam failure recovery. If a UE is not configured to monitor PDCCH for DCP, the UE 116 follows normal DRX operation. When the UE 116 operates with CA, the UE 116 may monitor PDCCH for DCP only on the PCell. One DCP can control PDCCH monitoring during a DRX on-duration for one or more UEs independently.

Rel-17 NR provides several additional features in support of reduced UE power consumption for UEs in RRC_IDLE/RRC_INACTIVE or in RRC_CONNECTED modes such as paging enhancements for UEs in RRC_IDLE/RRC_INACTIVE modes, the provision of potential transmission reference signal (TRS)/CSI-RS occasions available in RRC_CONNECTED mode to UEs in RRC_IDLE/RRC_INACTIVE modes, or PDCCH monitoring reduction features including SSSG switching or PDCCH skipping for UEs in RRC_CONNECTED mode, or relaxation of UE measurements for radio link monitoring (RLM) and/or BFD for UEs in RRC_CONNECTED mode.

Using Rel-17 NR, when a UE is configured with a PDCCH monitoring reduction feature, PDCCH monitoring by the UE 116 can be adapted by the gNB 102 for Type3-PDCCH common search space (CSS) sets or UE-specific search space (USS) sets on the active DL BWP of the serving cell. For example, as described in REF3, an adaptation can be triggered using a PDCCH monitoring adaptation indication field in DCI formats 0_1/0_2/1_1/1_2.

For example, SSSG switching may be configured using a Rel-17 configuration of SSSGs provided by higher layers. The UE 116 can be indicated to switch from a first SSSG to a second SSSG for PDCCH monitoring via an indication by a scheduling DCI. If a SSSG switch timer is also configured, the UE 116 switches to the SSSG with lowest group index after timer expiration if the UE 116 does not detect any DCI format with cyclic redundancy check (CRC) scrambled by cell-radio network temporary identifier (C-RNTI)/cell-specific (CS)-RNTI/modulation and coding scheme (MCS)-C-RNTI during the configured timer duration. The associated switching delay is at least P_{switch}symbols, where P_{switch} depends on the numerology of the active DL BWP for the UE 116 on the serving cell as described in REF3. The UE 116 can be configured with up to 3 SSSGs.

For example, PDCCH skipping mechanism may be configured for a UE. A configuration for a set of PDCCH skipping durations is provided to a UE by higher layers. A UE can be indicated to skip PDCCH monitoring for a duration from the set of durations, starting from a next slot after the slot of the PDCCH reception that provides the DCI format with the indication. A UE resumes PDCCH monitoring after the duration. The UE 116 ignores an indication for PDCCH skipping and continues to monitor PDCCH in several cases, for example as described in REF3. For example, one such case is when the UE 116 transmitted a PUCCH with positive SR and has not received a DCI format scheduling a PUSCH transmission. Another such case is when a contention resolution timer is running or during monitoring of the random access response (RAR)/MsgB window on an SpCell. Several additional cases can exist and are not captured for brevity.

A UE can be configured for both SSSG switching and PDCCH skipping. In such case, the UE 116 performs either SSSG switching or PDCCH skipping based on the indication by the PDCCH monitoring adaptation indication field in a DCI format 0_1/0_2/1_1/1_2 that can indicate either PDCCH skipping or SSSG switching as described in REF3.

When evaluating transmissions and receptions in a full-duplex wireless communication system, several issues related to limitations and drawbacks of existing technology need to be overcome.

It needs to be regarded that for transmissions by a gNB in a full-duplex system, a different number of transmitter/receiver antennas, a different effective transmitter antenna aperture area, and/or different transmitter antenna directivity settings may be available for gNB transmissions in a DL slot or symbol, i.e., non-SBFD slot or symbol, when compared to gNB transmissions in a SBFD slot or symbol. Similar considerations may apply to gNB receptions in a normal UL slot or symbol when compared to gNB receptions in the UL sub-band of a SBFD slot. The energy per resource element (EPRE) settings for gNB transmissions in a SBFD slot or symbol with full-duplex operation may be constrained to prevent gNB-side receiver automatic gain control (AGC) blocking and to enable effective implementation of serial interference cancellation (SIC) during gNB receptions in the UL subband of the SBFD slot or symbol when comparted to the EPRE settings of gNB transmissions in the normal DL slot. Therefore, the gNB 102 transmission power budget and, correspondingly, the received signal strength available for the UE 116 receiver may not be same for a signal/channel being transmitted by the gNB 102 on a non-SBFD slot/symbol when compared to transmission by the gNB 102 of a same signal/channel on an SBFD slot/symbol. Similar observations hold when full-duplex transmission and reception by a gNB antenna based on multiple antenna panels is implemented. Then, QCL and transmit timing aspects may vary between different panels, and transmissions or receptions from/by the gNB 102 may be subjected to different link gains depending on the antenna panel used for a transmission or reception instance.

Furthermore, interference levels experienced by the UE 116 receiver may differ between receptions in a normal DL slot or symbol and receptions in a SBFD slot or symbol. During receptions in a normal DL slot, the UE 116 receiver may be interfered by co-channel transmissions from neighbor gNBs. During receptions in an SBFD slot or symbol, the UE 116 receiver may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE 116 receiver may not be same for reception of signal/channels on non-SBFD slot/symbol when compared to reception of a signal/channel on an SBFD slot/symbol.

Due to the different received signal-to-interference-plus-noise (SINR) conditions in non-SBFD slots/symbols and in SBFD slots/symbols, it would be beneficial for a gNB to separately indicate to a UE to perform PDCCH monitoring adaptations in non-SBFD slots/symbols and in SBFD slots/symbols. For example, when the gNB 102 determines that a received SINR at the UE 116 is poor in SBFD slots/symbols, for example through a corresponding CSI report by the UE 116, the gNB 102 can indicate to the UE 116 to skip PDCCH monitoring in SBFD slots/symbols for a duration that can include next CSI reports by the UE 116 and the gNB 102 can indicate to the UE 116 to start PDCCH monitoring in SBFD slots/symbols when the received SINR at the UE 116 improves, for example, to support a 1% BLER for DCI format receptions based on at least one control channel element (CCE) aggregation level that the gNB 102 intends to use for the UE 116. Skipping PDCCH receptions by a UE in SBFD slots/symbols can enable the UE 116 to conserve power that increases as a number of consecutive SBFD slots/symbols increases as then the UE 116 can increase a time that a UE does not receive (longer “sleep” duration).

For example, when the gNB 102 determines that a received SINR at the UE 116 has improved in SBFD slots/symbols, for example through a corresponding CSI report by the UE 116, the gNB 102 can indicate to the UE 116 to switch from a first SSSG that includes a first number of PDCCH candidates for a large CCE aggregation level to a second SSSG that includes a second number of PDCCH candidates for the large CCE aggregation level where the first number is larger than the second number. Switching SSSGs based on indication by DCI according to short-term channel conditions by the UE 116 enables improved utilization of the UE 116 capability for PDCCH receptions as an allocation of number of PDCCH candidates per CCE aggregation level, of DCI formats, of CORESETs where the UE 116 monitors PDCCH, and so on, can be adapted by a serving gNB separately for non-SBFD symbols/slots and for SBFD symbols/slots.

In general, due to the different received SINR conditions and the different rate of variability in received SINR conditions at the UE 116 in SBFD slots/symbols and non-SBFD slots/symbols, it is beneficial to enable a gNB to separately adapt PDCCH monitoring, for PDCCH skipping or SSSG switching, in SBFD slots/symbols and in non-SBFD slots/symbols.

Therefore, embodiments of the present disclosure recognize there is a need to provide procedures for supporting separate indication for PDCCH skipping, and separate durations of PDCCH skipping, in non-SBFD slots/symbols and in SBFD slots/symbols.

There is another need to provide procedures for supporting separate indication for SSSG switching, and separate configuration of corresponding SSSGs, in non-SBFD slots/symbols and in SBFD slots/symbols.

There is another need to provide procedures for supporting a combination of the procedures for separate indication for PDCCH skipping and for SSSG switching in non-SBFD slots/symbols and in SBFD slots/symbols.

The disclosure addresses the above issues and evaluates methods for PDCCH monitoring indications, SSSG switching or PDCCH monitoring skipping where transmissions or receptions on non-SBFD or SBFD slots/symbols or configured SBFD subbands can be selectively configured, enabled or disabled.

Enhanced PDCCH skipping: Skipping of PDCCH monitoring for UE selectively enabled or disabled based on a slot or symbol type such as ‘SBFD’ or ‘non-SBFD’, or ‘D’ or ‘F’, or ‘D and F’ or based on an SBFD subband type, e.g., DL subband, UL subband, or flexible subband. Associated DCI design aspects (use of existing, extended or new PDCCH monitoring adaptation field in DCI) and RRC design aspects.

Further enhanced SSSG switching: Selective assignment of PDCCH monitoring based on SSSG with group index j for UE based on a slot or symbol type such as ‘SBFD’ or ‘non-SBFD’, or ‘D’ or ‘F’, or ‘D and F’ or based on an SBFD subband type, e.g., DL subband, UL subband, or flexible subband. Associated DCI design aspects (use of existing, extended or new PDCCH monitoring adaptation field in DCI) and RRC design aspects.

Other enhancements include separate SSSG assignments for SBFD and non-SBFD slots/symbols, possible SSSG j for PDCCH monitoring on non-SBFD slot while SSSG k is used on SBFD slots. Other enhancements include joint indications of SSSG and PDCCH skipping when using extended or new PDCCH monitoring adaptation field.

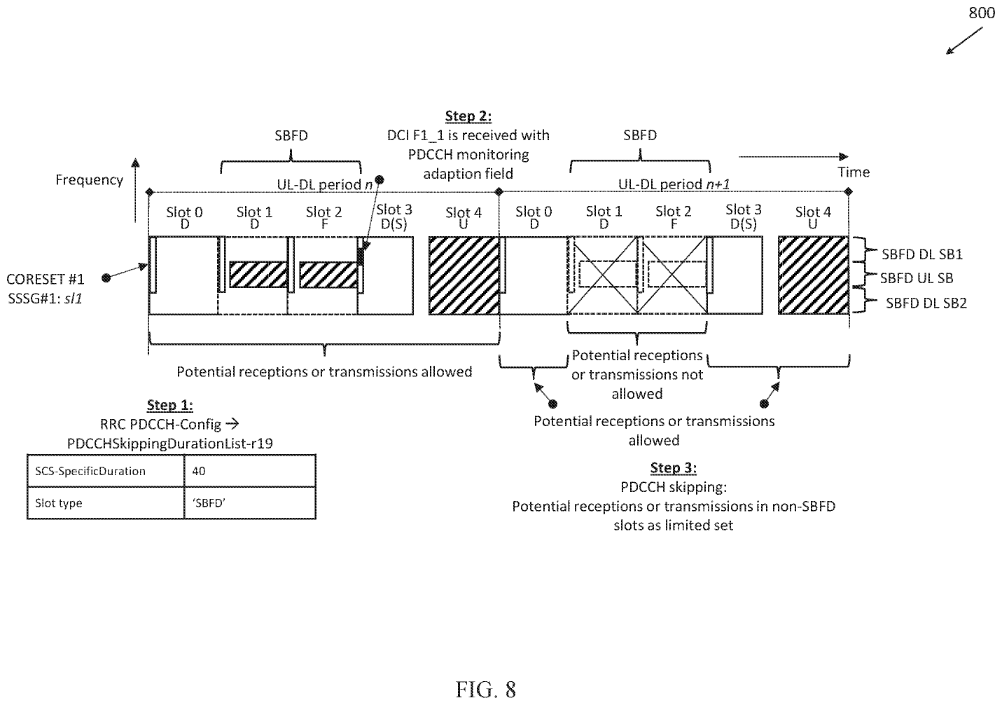

FIG. 8 illustrates a timeline 800 for PDCCH skipping according to embodiments of the disclosure. For example, timeline 800 for PDCCH skipping can be scheduled by the BS 102 of FIG. 1. This example is for illustration only and other embodiments can be used without departing from the scope of the present disclosure.

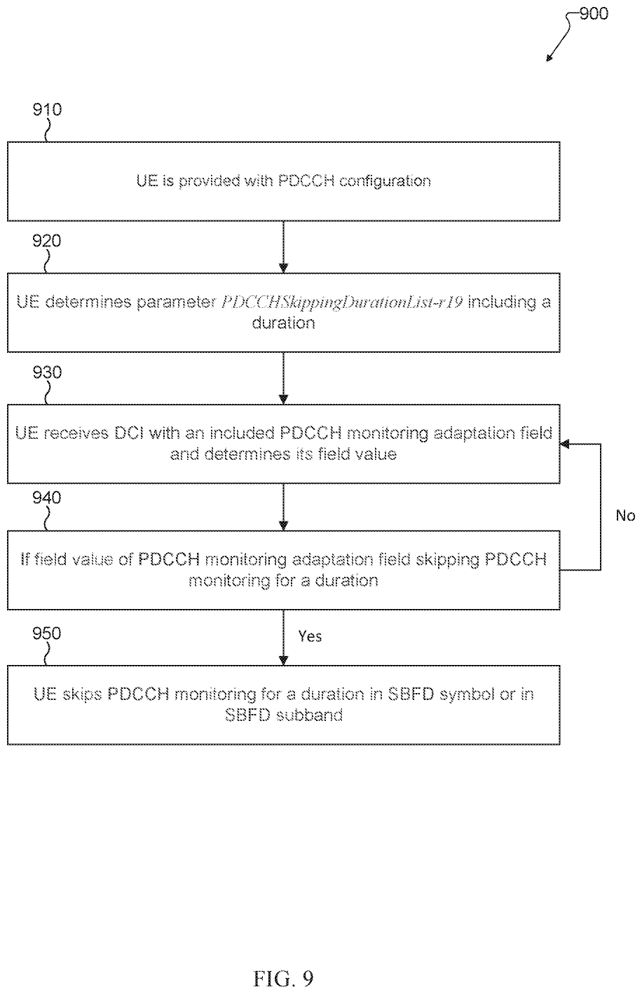

FIG. 9 illustrates a flowchart of an example UE procedure 900 for PDCCH skipping according to embodiments of the present disclosure. For example, procedure 900 for PDCCH skipping can be performed by any of the UEs 111-116 of FIG. 1. This example is for illustration only and other embodiments can be used without departing from the scope of the present disclosure.

The procedure begins in 910, a UE is provided with PDCCH configuration. In 920, the UE 116 determines parameter PDCCHSkippingDurationList-r19. In 930, the UE 116 receives DCI with an included PDCCH monitoring adaptation field and determines its field value. In 940, the field value of the PDCCH monitoring adaptation field may indicate skipping PDCCH monitoring for a duration. If the value indicates skipping PDCCH monitoring, in 950, the UE 116 skips PDCCH for a duration in SBFD symbol or in SBFD subband. If the value does not indicate skipping PDCCH monitoring, the procedure returns to 930.

In one embodiment, a UE is provided by higher layers from a serving gNB a new parameter PDCCHSkippingDurationList-r19 that selectively enables or disables PDCCH reception in a duration based on a slot or symbol type, e.g., ‘SBFD’ or ‘non-SBFD’, or ‘D’ or ‘F’, or ‘D and F’. The new parameter PDCCHSkippingDurationList-r19 may selectively enable or disable PDCCH reception based on an SBFD subband type, e.g., DL subband, UL subband, or flexible subband. For example, PDCCHSkippingDurationList-r19 can include separate sets of PDCCH skipping durations for SBFD symbols/slots and for non-SBFD symbols/slots.

In another embodiment, a UE is provided by higher layers from a serving gNB a new parameter PDCCHSkippingDurationList-r19 that selectively enables or disables PDCCH reception in a duration that is applicable only for ‘SBFD’ or ‘F’ slot or symbol types, is not applicable to ‘non-SBFD’ or ‘D’ slot or symbol types and includes a set of PDCCH skipping durations (that is applicable only for SBFD symbols/slots). For other types of slots or symbols, such as non-SBFD slots or symbols, a legacy PDCCHSkippingDurationList parameter is used to provide a set of durations for PDCCH skipping.

An indication value associated with PDCCHSkippingDurationList-r19 may be provided to the UE 116 using a unicast DCI such as DCI format 0_1/0_2/1_1/1_2 in REF2. The indication can be based on an existing PDCCH monitoring adaptation field, or an extended PDCCH monitoring adaptation field with additional bits, or a new field at least in case that the set of durations provided by PDCCHSkippingDurationList-r19 is applicable only to SBFD symbols or slots or subbands. The functionality of a PDCCH monitoring adaptation field for PDCCH skipping can also be applicable for a multicast DCI, for a PDCCH associated with multicast DCI formats, such as DCI format 4_0/4_1 in REF2.

For example, when an existing PDCCH monitoring adaptation field is used, a value of the field can map both to a PDCCH skipping duration value from the set of PDCCH monitoring duration values for non-SBFD symbols/slots, , and to a PDCCH skipping duration value from the set of PDCCH monitoring duration values for SBFD symbols/slots, such as a second value from the two sets of durations. For example, when a legacy PDCCH monitoring adaptation field of size M=2 bits is configured for a UE in a DCI with respective PDCCH monitoring on a serving cell and the set of durations provided to the UE 116 by PDCCHSkippingDurationList or by PDCCHSkippingDurationList-r19 includes three values, a value ‘00’ indicates no PDCCH skipping and values ‘01’/‘10’/‘11’ respectively indicate PDCCH skipping for a first/second/third duration from PDCCHSkippingDurationList in non-SBFD symbols/slots and for a first/second/third duration from PDCCHSkippingDurationList-r19 in SBFD symbols/slots on the active DL BWP of the serving cell.

For example, when an extended PDCCH monitoring adaptation field with additional bits is used, first bits of the field can indicate a first PDCCH skipping duration value for non-SBFD symbols/slots, and second bits of the field can indicate a second PDCCH skipping duration value for SBFD symbols/slots. For example, when both a legacy and a new PDCCH monitoring adaptation fields are provided by DCI, the legacy field can indicate a first PDCCH skipping duration value for non-SBFD symbols/slots, and the new field can indicate a second PDCCH skipping duration value for SBFD symbols/slots.

For example, when an extended PDCCH monitoring adaptation field of size M=4 bits is configured for a UE in a DCI with respective PDCCH monitoring on a serving cell and the set of durations provided to the UE 116 by PDCCHSkippingDurationList or by PDCCHSkippingDurationList-r19 includes three values, a value ‘00’ for the first two bits of the M=4 bits of the field indicates no PDCCH skipping, values ‘01’/‘10’/‘11’ respectively indicate PDCCH skipping for a first/second/third duration from PDCCHSkippingDurationList in non-SBFD symbols/slots while a value ‘00’ for the last two bits of the M=4 bits of the field indicates no PDCCH skipping, and values ‘01’/‘10’/‘11’ respectively indicate PDCCH skipping for a first/second/third duration from PDCCHSkippingDurationList-r19 in SBFD symbols/slots on the active DL BWP of the serving cell. For example, when an extended PDCCH monitoring adaptation field of size M=3 bits is configured for a UE in a DCI with respective PDCCH monitoring on a serving cell, and the set of durations provided to the UE 116 by PDCCHSkippingDurationList includes one value and the set of durations provided to the UE 116 by PDCCHSkippingDurationList-r19 includes three values, a value ‘0’ for the first bit of the M=3 bits of the field indicates no PDCCH skipping and a value ‘1’ indicates PDCCH skipping for (a first) duration from PDCCHSkippingDurationList in non-SBFD symbols/slots, a value ‘00’ for the last two bits of the M=3 bits of the field indicates no PDCCH skipping, and values ‘01’/‘10’/‘11’ respectively indicate PDCCH skipping for a first/second/third duration from

PDCCHSkippingDurationList-r19 in SBFD symbols/slots on the active DL BWP of the serving cell. Similar procedures apply if instead of bits from an extended PDCCH monitoring adaptation field, a new/additional PDCCH monitoring adaptation field is used to indicate a PDCCH skipping duration from PDCCHSkippingDurationList-r19 in SBFD symbols/slots.

In the following, parameter PDCCHSkippingDurationList-r19 can provide a first set of PDCCH skipping durations for non-SBFD symbols/slot and a second set of PDCCH skipping durations for SBFD symbols/slots or can provide only a set of PDCCH skipping durations for

SBFD symbols/slots while a legacy parameter PDCCHSkippingDurationList provides a set of PDCCH skipping durations for non-SBFD symbols/slots.

A PDCCH monitoring adaptation field in a DCI can be any of:
a legacy PDCCH monitoring adaptation field with a value that maps to more than one sets of values for respective more than one sets of durations for skipping PDCCH monitoring, where the more than one sets of durations are associated with non-SBFD slots and SBFD slots or with DL subbands or UL subbands or flexible subbands. The value may be applicable to both non-SBFD slots/symbols and SBFD slots/symbols or may be applicable only to slots/symbols of same type as the slot/symbols of the PDCCH reception with the DCI.
an extended PDCCH monitoring adaptation field, possibly with a number of bits that is larger than in case of non-full-duplex operation, where first bits from the number of bits provide a first value that maps to a first duration for skipping PDCCH monitoring in non-SBFD slots and second bits from the number of bits provide a second value that maps to a second duration for skipping PDCCH monitoring in SBFD slots. In similar manner, second bits from the number of bits may provide a second value that maps to a second duration for skipping PDCCH monitoring in DL subbands or UL subbands or flexible subbands. The first and second durations can be from a same set of durations or from separately provided sets of durations. In that latter case, a number of first bits and a number of second bits can be different and be determined from a size of a corresponding set of durations.
a new PDCCH monitoring adaptation field that is applicable to SBFD slots or symbols, or to PDCCH receptions in a configured or indicated UL subband or flexible subband, while a legacy PDCCH monitoring adaptation field is applicable to non-SBFD slots or symbols or to PDCCH receptions in DL subbands. A first number of bits for the legacy PDCCH monitoring adaptation field can be different from a second number of bits for the new PDCCH monitoring adaptation field, where the first and second numbers of bits can be determined from the sizes of corresponding sets of durations.

In another embodiment, an indication to selectively enable or disable PDCCH reception in a duration based on a slot or symbol type, or based on an SBFD subband type, may be provided to the UE 116 by an association with a slot or symbol type or by an association with an SBFD subband type where the UE 116 receives such an indication. Therefore, an interpretation by the UE 116 for an applicability of a PDCCH monitoring adaptation field in a DCI format can be for types of symbols or slots or subbands, such as non-SBFD or SBFD, that are same as a type of symbols or slots or subbands where the UE 116 received a PDCCH that provided the DCI format and the indication by the PDCCH monitoring adaptation field in the DCI format is not applicable for PDCCH monitoring in symbols or slots or subbands of different types.

For example, a UE that is provided PDCCHSkippingDurationList-r19 may be indicated a duration through PDCCH monitoring adaptation field value in a DCI for the UE 116 to skip PDCCH receptions in SBFD slots/symbols, but not to skip PDCCH receptions in non-SBFD slots/symbols. In another example, a UE that is provided PDCCHSkippingDurationList-r19 may be indicated a duration through an indication value in a DCI for the UE 116 to skip PDCCH receptions in slots/symbols of type ‘F’, but not to skip PDCCH receptions in slots/symbols of type ‘D’.

For example, a UE that is provided PDCCHSkippingDurationList-r19 that includes a set of PDCCH skipping durations, may be indicated a duration from the set of PDCCH skipping durations through a value of a PDCCH monitoring adaptation field in a DCI, for example as previously described, for skipping PDCCH receptions when respective PDCCH monitoring occasions coincide or at least partially overlap on symbols with a selected and designated SBFD subband type and PDCCH receptions are not skipped otherwise. In another example, the gNB 102 may configure the UE 116 to skip PDCCH receptions when corresponding PDCCH monitoring occasions overlap with an SBFD flexible subband but to not skip PDCCH receptions when corresponding PDCCH monitoring occasions are within an SBFD DL or UL subband.

For example, a UE that is provided PDCCHSkippingDurationList-r19 may be indicated a duration, through a value of a PDCCH monitoring adaptation field in a DCI, for the UE 116 to skip PDCCH receptions for a slot type or symbol type where the UE 116 receives the PDCCH providing the DCI, but the UE 116 does not skip PDCCH receptions for another slot type or symbol type. In an example, the gNB 102 transmits to the UE 116 a PDCCH with a DCI that includes a PDCCH monitoring adaptation field on a sub-band full duplex (SBFD) symbol or slot where a value of the field, e.g., a codepoint of the field, indicates a duration for PDCCH skipping from the set of durations. The UE 116 then skips PDCCH receptions for the duration on symbols with same type as the symbols where the UE 116 received the PDCCH, e.g., on SBFD symbol(s), and the UE 116 does not skip PDCCH reception for the duration on other symbol types, e.g., non-SBFD symbols. In another example, the gNB 102 transmits to the UE 116 a PDCCH with a DCI that includes a PDCCH monitoring adaptation field on a flexible symbol/slot where a value of the field, e.g., codepoint of the field, indicates a duration for PDCCH skipping from the set of durations. The UE 116 then skips PDCCH reception for the duration on symbols with same type as the symbols where the UE 116 received the PDCCH, e.g., flexible symbols, and does not skip PDCCH receptions for the duration on other symbol types, e.g., DL symbols. The duration can correspond to all types of symbols or slots or to only the associated type of symbols or slots. For example, when the duration is in terms of slots and has a value of 20 slots, the 20 slots can be any slots or can be only slots PDCCH receptions are according to SBFD (or non-SBFD) operation.

Similar solutions as described may be used for indication to a UE to skip PDCCH receptions in an SBFD subband type that is same as an SBFD subband type where the UE 116 receives the PDCCH that includes a DCI with the indication for PDCCH skipping. For example, the gNB 102 transmits to the UE 116 a PDCCH that includes a DCI with a PDCCH monitoring adaptation field on an SBFD flexible subband, e.g., where a flexible subband allows for the possibilities of transmissions from the UE 116 or for receptions by the UE 116. The indication by the PDCCH monitoring adaptation field, e.g., the codepoint of the field indicates PDCCH skipping for a duration from the applicable set or durations. The UE 116 then skips PDCCH receptions for the duration on the SBFD subband where the UE 116 received the PDCCH with the DCI, e.g., flexible subband, and does not skip PDCCH receptions for the duration in other subband types, e.g., DL subbands.

A motivation for enabling different UE behaviors, including different durations, for PDCCH skipping in non-SBFD symbols or slots and in SBFD symbols or slots is increased link robustness when operating on a serving cell supporting full-duplex operation. By selectively enabling or disabling PDCCH monitoring based on a slot/symbol type, or based on an SBFD subband type using PDCCHSkippingDurationList-r19, a gNB can dynamically restrict PDCCH monitoring by a UE to a subset of time-domain or frequency-domain resources and enable a UE to save power by not monitoring PDCCH in remaining time-domain or frequency-domain resources, particularly when a result is that the UE 116 does not monitor PDCCH over at least a few milliseconds, such as more than 3-4 milliseconds. For example, the gNB 102 may adjust the PDCCH monitoring by the UE 116 to occur in non-SBFD slots or symbols where the UE 116 experiences better received SINR conditions and skip PDCCH receptions on non-SBFD slots for a duration until the received SINR conditions for the UE 116 are re-assessed.

For example, PDCCHSkippingDurationList-r19 may be included in one or more RRC messages and/or IEs and a parameter PDCCHSkippingDurationList-r19 may be received by the UE 116 based on a system information block (SIB), such as a SIB1, or by a common RRC signaling, or by UE-specific RRC signaling. For example, and without loss of generality, PDCCHSkippingDurationList-r19 may be provided by the gNB 102 to the UE 116 as part of RRC messages of type RRCSetup, RRCReconfiguration, SIB1 or SystemInformation, or may be included in RRC IEs of type ServingCellConfig, ServingCellConfigCommon, or ServingCellConfigSIB1. Such RRC configuration parameters may be of enumerated, listed or sequence type or may be encoded as a bit string. In one example, PDCCHSkippingDurationList-r19 may be included in an IE of type PDCCH-Config. Multiple parameter sets for PDCCHSkippingDurationList-r19 may be provided to the UE 116.

For example, the UE 116 may be provided a set or list of skipping durations for PDCCH monitoring by PDCCHSkippingDurationList-r19. A set or a group of serving cells may be associated with a PDCCHSkippingDurationList-r19. A value for a skipping duration may be associated with or be defined with reference to an SCS, such as an SCS of an active DL BWP or of a reference DL BWP, or with reference to a reference SCS such as 15 kHz, or in terms or absolute time such as milliseconds. A value from the values of skipping durations can correspond to a default duration or to a remaining of a DRX on-duration. PDCCHSkippingDurationList-r19 may include a different allowed set of skipping durations, or a larger maximum allowed value, than SCS-SpecificDuration-r17, e.g., larger than 200 in units of slots or 100 msec for SCS=30 kHz.

A UE may be provided PDCCHSkippingDurationList-r19 that includes multiple sets of PDCCH monitoring durations where a set may be associated to one or more of:
a slot or symbol type, e.g., ‘SBFD’ or ‘non-SBFD’, or ‘D’ or ‘F’ or ‘D and F’, or
an SBFD subband type, e.g., DL subband, UL subband, or flexible subband type, or
an SBFD subband type with a slot or symbol type or SBFD subband type.

PDCCHSkippingDurationList-r19 can indicate slot/symbol indices or a set of slots/symbols where a UE skips or does not skip PDCCH receptions for a duration. The UE 116 may be provided time-domain resources, e.g., slots/symbols, where the UE 116 skips or does not skip PDCCH receptions for a duration even when the UE 116 determines that a slot/symbol or a slot/symbol type where a PDCCH reception may occur is part of a PDCCH configuration, e.g., associated with a PDCCH monitoring occasion. For example, PDCCHSkippingDurationList-r19 can indicate presence or absence of PDCCH monitoring over a subset of slots/symbols in a set of slots/symbols of a DL-UL frame configuration with period p. For example, the UE 116 may be provided a list or sequence or bitmap representative of M slots/symbols from the set of N slots/symbols in a period p. A UE may determine for PDCCH monitoring a subset of M slots/symbols from the set of N slots/symbols. For example, the UE 116 may determine the first or the last M slots/symbols from a set of N slots/symbols as a subset. For example, M may be 1 or M may be associated with default values. Multiple subsets of slots/symbols may be provided to the UE 116 or be determined by the UE 116.

PDCCHSkippingDurationList-r19 may include a bitmap to indicate time-domain resources, such as based on an RRC parameter monitoringSlotsWithinSlotGroup or monitoringSymbolsWithinSlot, or frequency-domain resources based on an RRC parameter freqMonitorLocations for PDCCH monitoring. PDCCHSkippingDurationList-r19 may be associated with PDCCH monitoring using a CCE aggregation level, such as for example for a UE to skip PDCCH receptions with an indicated CCE aggregation level, such as 8, for an indicated duration. PDCCHSkippingDurationList-r19 may be associated with a resource type indication for skipping PDCCH receptions, such as a slot or symbol or symbol group of a radio resource that may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type may be associated with a configured or an indicated SBFD UL and/or DL subband. An indication of the resource type may be provided independently of the transmission direction of a slot or symbol indicated to the UE 116 by the TDD UL-DL frame configuration provided by higher layers.

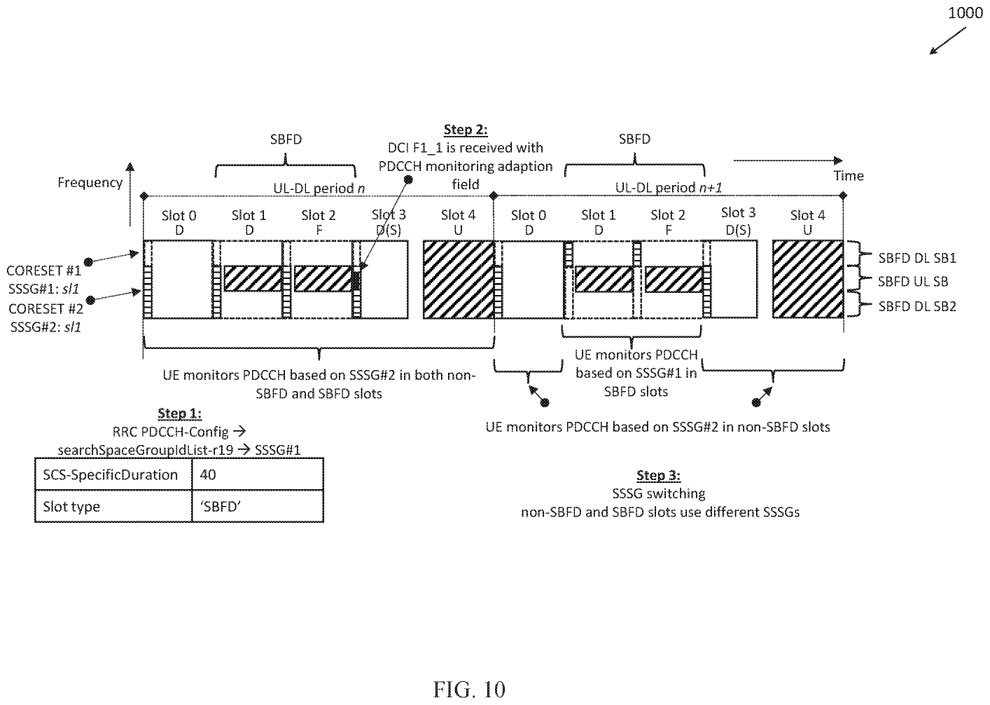

FIG. 10 illustrates a timeline 1000 for SSSG switching according to embodiments of the disclosure. For example, timeline 1000 for SSSG switching can be scheduled by the BS 103 of FIG. 1. This example is for illustration only and other embodiments can be used without departing from the scope of the present disclosure.

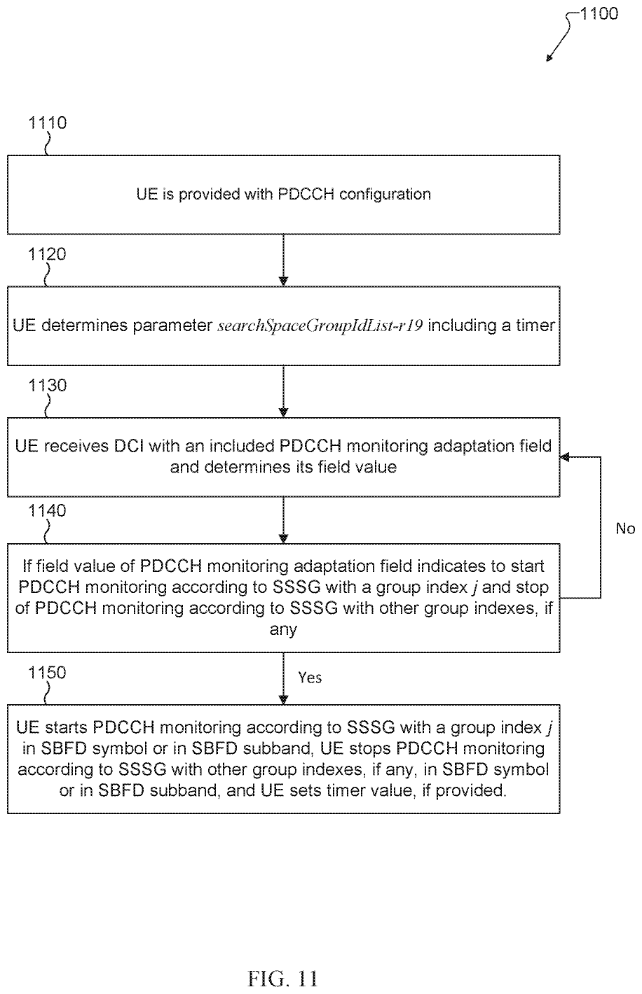

FIG. 11 illustrates a flowchart of an example UE procedure 1100 for SSSG switching according to embodiments of the present disclosure. For example, procedure 1100 for

SSSG switching can be performed by the UE 116 of FIG. 3. This example is for illustration only and other embodiments can be used without departing from the scope of the present disclosure.

The procedure begins in 1110, a UE is provided with PDCCH configuration. In 1120, the UE 116 determines parameter searchSpaceGroupIdList-r19 including a timer. In 1130, the UE 116 receives DCI with an included PDCCH monitoring adaptation field and determines its field value. In 1140, the field value of PDCCH monitoring adaptation field may indicate to start PDCCH monitoring according to SSSG with a group index j and stop of PDCCH monitoring according to SSSG with other group indexes, if any. If the field value of PDCCH monitoring adaptation field indicates to start PDCCH monitoring according to SSSG with a group index j and stop of PDCCH monitoring according to SSSG with other group indexes, in 1150, the UE 116 starts PDCCH monitoring according to SSSG with a group index j in SBFD symbol or in SBFD subband, UE stops PDCCH monitoring according to SSSG with other group indexes, if any, in SBFD symbol or in SBFD subband, and UE sets timer value, if provided. If the value of PDCCH monitoring adaptation field does not indicate to start PDCCH monitoring according to SSSG with a group index j and stop of PDCCH monitoring according to SSSG with other group indexes, the procedure returns to 1130.

In one embodiment, the UE 116 is provided by higher layers from a serving gNB a new parameter searchSpaceGroupIdList-r19 that selectively assigns a SSSG for PDCCH monitoring based on a slot or symbol type, e.g., ‘SBFD’ or ‘non-SBFD’, or ‘D’ or ‘F’ or ‘D and F’. The new parameter searchSpaceGroupIdList-r19 may selectively assign a SSSG based on an SBFD subband type, e.g., DL subband, UL subband, or flexible subband.

In another embodiment, a UE is provided by higher layers from a serving gNB a new parameter searchSpaceGroupIdList-r19 that selectively assigns a SSSG for PDCCH monitoring only for ‘SBFD’ or ‘F’ slot or symbol types or for an UL subband or a flexible subband. For other types of slots or symbols, such as non-SBFD slots or symbols, a legacy searchSpaceGroupIdList parameter is used to selectively assign a SSSG for PDCCH monitoring.

Parameter searchSpaceGroupIdList-r19 for PDCCH monitoring based on an SSSG may be associated with a duration, a trigger, or a fallback condition.

An indication value associated with searchSpaceGroupIdList-r19 may be provided to the UE 116 using a unicast DCI such as DCI format 0_1/0_2/1_1/1_2 in REF2. The indication can be based on an existing PDCCH monitoring adaptation field, or an extended PDCCH monitoring adaptation field with additional bits, or a new field at least in case that an SSSG for PDCCH monitoring provided by searchSpaceGroupIdList-r19 is applicable only to SBFD symbols or slots or subbands. The functionality of a PDCCH monitoring adaptation field for SSSG switching can also be applicable for a multicast DCI, for SSSGs associated with multicast DCI formats, such as DCI format 4_0/4_1 in REF2.

For example, when an existing PDCCH monitoring adaptation field is used, a first value of the field can selectively assign a SSSG from the set of SSSGs for PDCCH monitoring on non-SBFD symbols/slots, e.g., indicate start of PDCCH monitoring according to an SSSG with group index j and stop of PDCCH monitoring according to an SSSG with another group index and a second value of the field can selectively assign a SSSG from the set of SSSGs for PDCCH monitoring on SBFD symbols/slots. For example, when an existing PDCCH monitoring adaptation field of size M=2 bits is configured for a UE in a DCI with respective PDCCH monitoring on a serving cell and the set of SSSGs provided to the UE 116 by searchSpaceGroupIdList or by searchSpaceGroupIdList-r19 includes three SSSGs, a value ‘00’/‘01’/‘10’ respectively indicates a first/second/third SSSG from searchSpaceGroupIdList in non-SBFD symbols/slots and a first/second/third SSSG from searchSpaceGroupIdList-r19 in SBFD symbols/slots for PDCCH monitoring on the active DL BWP of the serving cell.

For example, when an extended PDCCH monitoring adaptation field of size M=4 bits is configured for a UE in a DCI with respective PDCCH monitoring on a serving cell and the set of SSSGs provided to the UE 116 by searchSpaceGroupIdList or by searchSpaceGroupIdList-r19 includes three SSSGs, a value ‘00’/‘01’/‘10’ for the first two bits respectively indicates a first/second/third SSSG from searchSpaceGroupIdList for PDCCH monitoring in non-SBFD symbols/slots and a value of ‘00’/'01′/'10′ for the last two bits respectively indicates a first/second/third SSSG from searchSpaceGroupIdList-r19 for PDCCH monitoring in SBFD symbols/slots on the active DL BWP of the serving cell. For example, when an extended PDCCH monitoring adaptation field of size M=3 bits is configured for a UE in a DCI with respective PDCCH monitoring on a serving cell and the set of SSSGs provided to the UE 116 by searchSpaceGroupIdList includes two SSSGs and the set of SSSGs provided to the UE 116 by PDCCHSkippingDurationList-r19 includes three SSSGs, a value ‘0’/‘1’ for the first bit of the M=3 bits of the field respectively indicates a first/second/third SSSG from searchSpaceGroupIdList for PDCCH monitoring in non-SBFD symbols/slots and a value of ‘00’/‘01’/‘10’ for the last two bits respectively indicates a first/second/third SSSG from searchSpaceGroupIdList-r19 for PDCCH monitoring in SBFD symbols/slots on the active DL BWP of the serving cell. Similar procedures apply if instead of bits from an extended PDCCH monitoring adaptation field, a new/additional PDCCH monitoring adaptation field is used to indicate a SSSG from searchSpaceGroupIdList-r19 in SBFD symbols/slots.

In the following, parameter searchSpaceGroupIdList-r19 can assign an SSSG from a first set of SSSGs for PDCCH monitoring for non-SBFD symbols/slot and an SSSG from a second set of SSSGs for PDCCH monitoring for SBFD symbols/slots or can assign only an SSSG from a second set of SSSGs for PDCCH monitoring for SBFD symbols/slots while a legacy parameter searchSpaceGroupIdList can assign an SSSG from a first set of SSSGs for PDCCH monitoring for non-SBFD symbols/slots.

A PDCCH monitoring adaptation field in a DCI can be any of the following:
a legacy PDCCH monitoring adaptation field with at least one value that maps to an assigned set from a set of SSSGs for PDCCH monitoring that is associated with non-SBFD slots and SBFD slots or with DL subbands or UL subbands or flexible subbands. The value may be applicable to both non-SBFD slots/symbols and SBFD slots/symbols or may be applicable only to slots/symbols of same type as the slot/symbols of the PDCCH reception with the DCI . . .
an extended PDCCH monitoring adaptation field, possibly with a number of bits that is larger than in case of non-full-duplex/legacy operation, where first bits from the number of bits provide a first value that maps to an SSSG from a first set of SSSGs for PDCCH monitoring in non-SBFD slots and second bits from the number of bits provide a second value that maps to an SSSG from a second set of SSSGs for PDCCH monitoring in SBFD slots. In similar manner, second bits from the number of bits may provide a second value that maps to an SSSG from a second set of SSSGs for PDCCH monitoring in DL subbands or UL subbands or flexible subbands. The first and second set of SSSGs can be from a same set of SSSGs or from separately provided SSSGs sets.
a new PDCCH monitoring adaptation field that is applicable to SBFD slots or symbols, or to PDCCH receptions in a configured or indicated UL subband or flexible subband while a legacy PDCCH monitoring adaptation field is applicable to non-SBFD slots or symbols, or to PDCCH receptions in DL subbands.

In another embodiment, an indication to selectively assign an SSSG for PDCCH monitoring based on a slot or symbol type or based on an SBFD subband type may be provided to the UE 116 by association with a slot or symbol type or by association with an SBFD subband type, where the UE 116 receives a PDCCH that includes a DCI format with the indication. Therefore, an interpretation by the UE 116 for an applicability of a PDCCH monitoring adaptation field in a DCI format can be for types of symbols or slots or subbands, such as non-SBFD or SBFD, that are same as a type of symbols or slots or subbands where the UE 116 received a PDCCH that provided the DCI format and the indication by the PDCCH monitoring adaptation field in the DCI format is not applicable for PDCCH monitoring in symbols or slots or subbands of different types.

When searchSpaceGroupIdList-r19 selectively assigns a SSSG for PDCCH monitoring based on a slot or symbol type, or based on a subband type, an indication value provided to the UE 116 may be associated with more than one SSSG. For example, an indication value may be associated with an entry to searchSpaceGroupIdList-r19 that simultaneously assigns a first SSSG to a first slot/symbol type or SBFD subband type and a second SSSG to a second slot/symbol type or SBFD subband type for PDCCH monitoring by the UE 116.

When searchSpaceGroupIdList-r19 assigns a SSSG for PDCCH monitoring only for SBFD symbols or slots, or only for SBFD subbands, a legacy field (or first bits of an extended legacy field) for an indication value of a legacy RRC parameter searchSpaceGroupIdList may be used for a first type of slots or symbols or subbands, such as non-SBFD slots or symbols or DL subbands, and a new field (or second bits of an extended legacy field) for an indication value or RRC parameter searchSpaceGroupIdList-r19 may be used for a second type of slots or symbols or subbands, such as SBFD slots or symbols or UL or flexible subbands.

A UE may be indicated and/or assigned different SSSGs for PDCCH monitoring in different slot or symbol types, such as SBFD or non-SBFD symbols or slots, or in different SBFD subband types, such as SBFD or non-SBFD subbands, where PDCCH reception is configured for the UE 116. For example, a SSSG with group index 0 may be assigned to a UE for PDCCH monitoring on non-SBFD symbols while a SSSG with group index 1 maybe assigned to the UE 116 on SBFD symbols.

Therefore, an indication for SSSG switching to a designated SSSG, or a fallback to a default SSSG after counter expiry, when monitoring a PDCCH on a first slot/symbol type or on a first SBFD subband type may be provided to the UE 116 concurrently or separately from an indication for SSSG switching or a fallback to a default SSSG for a second slot/symbol type or a second SBFD subband type. Further, separate switching delays P_{SWITCH} symbols may apply for SSSG switching on different slot/symbol types or for different SBFD subband types due to potentially different corresponding UE receiver requirements. For example, separate timer or counter values for a searchSpaceSwitchTimer may be provided to the UE 116, or separate corresponding variable counts may be maintained by the UE 116 when monitoring PDCCH for separate slot/symbol types or for separate SBFD subband types. For example, for a same RRC timer value provided by searchSpaceSwitchTimer to a UE for PDCCH monitoring on non-SBFD and on SBFD symbols, respectively, the UE 116 may determine that the timer expires earlier on SBFD symbols than on non-SBFD symbols when monitoring PDCCH on the serving cell when the UE 116 detects fewer DCI formats on the SBFD symbols, e.g., the UE 116 resets the associated timer value fewer times. Correspondingly, the UE 116 may fall back to a default SSSG with group index 0 for PDCCH monitoring on SBFD symbols while the UE 116 monitors PDCCH on the non-SBFD symbols based on SSSG with a group index 1.

For example, when a UE is provided an SBFD subband configuration by the gNB 102, the UE 116 determines and/or applies a selected SSSG for PDCCH monitoring for a slot or symbol type or for a SBFD subband type. For example, a UE may expect to monitor PDCCH based on SSSG group index 0 on a SBFD symbol/slot when the UE 116 is provided with an SBFD subband configuration or when an SBFD subband configuration is re-configured for the UE 116. Alternatively, the SSSG group index for PDCCH monitoring upon SBFD (re-)configuration may be provided to a UE. For example, a UE may expect to reset PDCCH monitoring based on SSSG group index 0 on a non-SBFD symbol/slot when the UE 116 is provided with an SBFD subband configuration or when an SBFD subband configuration is re-configured for the UE 116. Alternatively, the SSSG group index for PDCCH monitoring in non-SBFD slot/symbols upon SBFD (re-)configuration may be provided to a UE.

For example, a UE that is provided searchSpaceGroupIdList-r19 may be selectively assigned an SSSG for PDCCH monitoring for an SBFD slot/symbol through an indication value of a PDCCH monitoring adaptation field in a DCI. In another example, a UE that is provided searchSpaceGroupIdList-r19 may be selectively assigned an SSSG for PDCCH monitoring through an indication value in a DCI for a slot or/symbol of type ‘F’. For example, a UE that is provided searchSpaceGroupIdList-r19 may be selectively assigned a first SSSG with group index n1 for PDCCH monitoring through an indication value of the PDCCH monitoring adaptation field in a DCI for PDCCH monitoring in a slot/symbol of type ‘D’ and a second SSSG with group index n2 for PDCCH monitoring in a slot/symbol of type ‘F’.

For example, a UE that is provided searchSpaceGroupIdList-r19 may be selectively assigned an SSSG for PDCCH monitoring through an indication value of a PDCCH monitoring adaptation field in a DCI that allows or disallows PDCCH monitoring on a symbol where a PDCCH reception includes (at least partially) a selected or a designated SBFD subband type configured for the UE 116 on the symbol. The UE 116 attempts to receive a PDCCH based on an assigned SSSG when no SBFD subband is configured on symbols of PDCCH receptions or when another SBFD subband type is configured on those symbols. In an example, searchSpaceGroupIdList-r19 may indicate to a UE that PDCCH monitoring by the UE 116 for a SSSG with group index n1 is disabled when a PDCCH monitoring occasion coincides with an SBFD UL subband and UE monitors PDCCH based on the SSSG with group index n1 when PDCCH monitoring occasions are contained in an SBFD DL subband. In another example, searchSpaceGroupIdList-r19 may indicate to a UE to not monitor PDCCH based on SSSG with group index n1 on a symbol when coinciding with an SBFD flexible subband on the symbol but to monitor PDCCH using SSSG n1 when the symbol is configured with an SBFD DL subband.

For example, a UE that is provided searchSpaceGroupIdList-r19 may be selectively assigned an SSSG for PDCCH monitoring through an indication value of a PDCCH monitoring adaptation field in a DCI for a slot or symbol type where the UE 116 received the PDCCH providing the DCI, but the assignment does not apply to SSSGs for PDCCH monitoring in another slot or symbol type. In an example, the UE 116 receives PDCCH with a DCI containing a PDCCH monitoring adaptation field on an SBFD symbol or slot and the field value or codepoint of the field is associated with a change in the assigned SSSG to an SSSG with group index n1. The UE 116 then re-configures PDCCH monitoring to the SSSG with group index n1 for the symbol or slot type on which the UE 116 received the PDCCH with the DCI, e.g., an SBFD symbol, but the UE 116 does not re-configure PDCCH monitoring using an SSSG with group index n2 on another symbol type, e.g., non-SBFD symbol. In another example, the UE 116 receives a DCI with a PDCCH monitoring adaptation field on a flexible symbol or slot where the indicated field value or codepoint of the field is associated with a change in the assigned SSSG to an SSSG with group index n1. The UE 116 then starts PDCCH monitoring using SSSG with group index n1 for the symbol type where the UE 116 received the PDCCH providing the DCI, e.g., flexible symbols, but the UE 116 does not start PDCCH monitoring based on the indicated SSSG with group index n1 for another symbol type, e.g., DL symbols, where PDCCH monitoring based on another SSSG with another group index may be performed by the UE 116.

Similar solutions as described may be used for indication to selectively assign an SSSG for PDCCH monitoring that is the same as an SBFD subband type where the UE 116 receives a PDCCH that includes a DCI with the indication for SSSG switching. For example, the gNB 102 transmits to the UE 116 a PDCCH that includes a DCI with a PDCCH monitoring adaptation field on an SBFD flexible subband, e.g., where a flexible subband allows for the possibilities for transmissions from the UE 116 or for receptions by the UE 116. The indication by the PDCCH monitoring adaptation field, e.g., the codepoint of the field indicates to the UE 116 to start PDCCH monitoring using SSSG with group index n2 (and stop monitoring PDCCH using another SSSG). the UE 116 then starts monitoring PDCCH based on SSSG n2 on the SBFD subband where the UE 116 received the PDCCH with the DCI, e.g., flexible subband, and the UE 116 does not apply the indication in other subband types, e.g., DL subbands.

A motivation for enabling different UE behaviors for SSSG switching in SBFD symbols or slots or subbands and in non-SBFD symbols or slots is increased link robustness when operating on a serving cell supporting full-duplex operation. By selectively assigning an SSSG for PDCCH monitoring based on a slot/symbol type or based on an SBFD subband type using searchSpaceGroupIdList-r19, the gNB 102 can dynamically restrict the PDCCH monitoring by a UE to a subset of time-domain or frequency-domain resources. For example, the gNB 102 may adjust the PDCCH monitoring by the UE 116 to occur in DL SBFD subbands where the UE 116 may experience less inter-UE CLI than in an SBFD flexible subband. The gNB 102 can also separately adapt the search space sets used for scheduling, such as number of PDCCH candidates per CCE aggregation level or a PDCCH monitoring periodicity, based on the received SINR conditions at the UE 116 in SBFD subbands which can vary differently, such as more frequently, than the received SINR conditions in non-SBFD subbands, or based on the amount of UL traffic the UE 116 has remaining.

For example, searchSpaceGroupIdList-r19 may be included in one or more RRC messages and/or IEs and searchSpaceGroupIdList-r19 may be received by the UE 116 based on a system information block (SIB), such as a SIB1, or by a common RRC signaling, or by UE-specific RRC signaling. For example, and without loss of generality, such information may be provided by the gNB 102 to the UE 116 as part of RRC messages of type RRCSetup, RRCReconfiguration, SIB1 or SystemInformation, or may be included in RRC IEs of type ServingCellConfig, ServingCellConfigCommon, or ServingCellConfigSIB1. Such RRC configuration parameters may be of enumerated, listed or sequence type, or may be encoded as a bit string. In one example, the parameter indicating searchSpaceGroupIdList-r19 may be included in an IE of type PDCCH-Config. Multiple parameter sets for searchSpaceGroupIdList-r19 may be provided to the UE 116.

For example, the UE 116 may be provided a set or list of switching timers and/or switching delays as part of searchSpaceGroupIdList-r19. A set or a group of serving cells may also be associated with searchSpaceGroupIdList-r19. A value for a switching duration, or a value for a switching delay, may be associated with or be defined with reference to an SCS, such as an SCS of an active DL BWP on the serving cell or a reference SCS such as 15 kHz or in absolute time such as in milliseconds, and may use a default timer or a default delay value. Parameter searchSpaceGroupIdList-r19 may include a different allowed set of switching timer values or a larger maximum allowed switching timer value than SCS-SpecificDuration-r17, e.g., larger than 200 in units of slots or 100 msec for SCS=30 kHz.

A UE may be provided searchSpaceGroupIdList-r19 that includes at least one set of SSSGs for PDCCH monitoring where a set may be associated to one or more of
a slot or symbol type, e.g., ‘SBFD’ or ‘non-SBFD’, or ‘D’ or ‘F’ or ‘D and F’;
an SBFD subband type, e.g., DL subband, UL subband, or flexible subband type; or
an SBFD subband type with a slot or symbol type or SBFD subband type.

A UE may be indicated by searchSpaceGroupIdList-r19 slot/symbol indices or a set of slots/symbols where PDCCH monitoring based on an SSSG is expected or not expected. The UE 116 may be provided with time-domain resources, e.g., slots/symbols, for the UE 116 to determine when PDCCH monitoring based on an SSSG from the UE 116 is expected or not expected in a duration. For example, a UE may be indicated by searchSpaceGroupIdList-r19 a subset of slots/symbols in the set of slots/symbols of a DL-UL frame configuration of a period p for PDCCH monitoring. For example, the UE 116 may be provided a list or sequence or bitmap representative of M slots/symbols from the set of N slots/symbols in a period p. A UE may determine a subset of M slots/symbols from the set of N slots/symbols. For example, the UE 116 may determine the first or the last M slots/symbols from a set of N slots/symbols as a subset. For example, M may be 1 or M may be associated with default values. Multiple subsets of slots/symbols may be provided to the UE 116 or be determined by the UE 116.

searchSpaceGroupIdList-r19 may include a bitmap to indicate a time-domain resource such as based on an RRC parameter monitoringSlotsWithinSlotGroup or monitoringSymbolsWithinSlot or a frequency-domain resource based on an RRC parameter freqMonitorLocations. searchSpaceGroupIdList-r19 to selectively assign PDCCH monitoring based on an SSSG may be associated with a resource type indication that a slot or symbol or symbol group of a radio resource may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type indication may be associated with a configured or an indicated SBFD UL and/or DL subband. An indication of the resource type may be provided independently of the transmission direction of a slot or symbol indicated to the UE 116 by the TDD UL-DL frame configuration provided by higher layers.

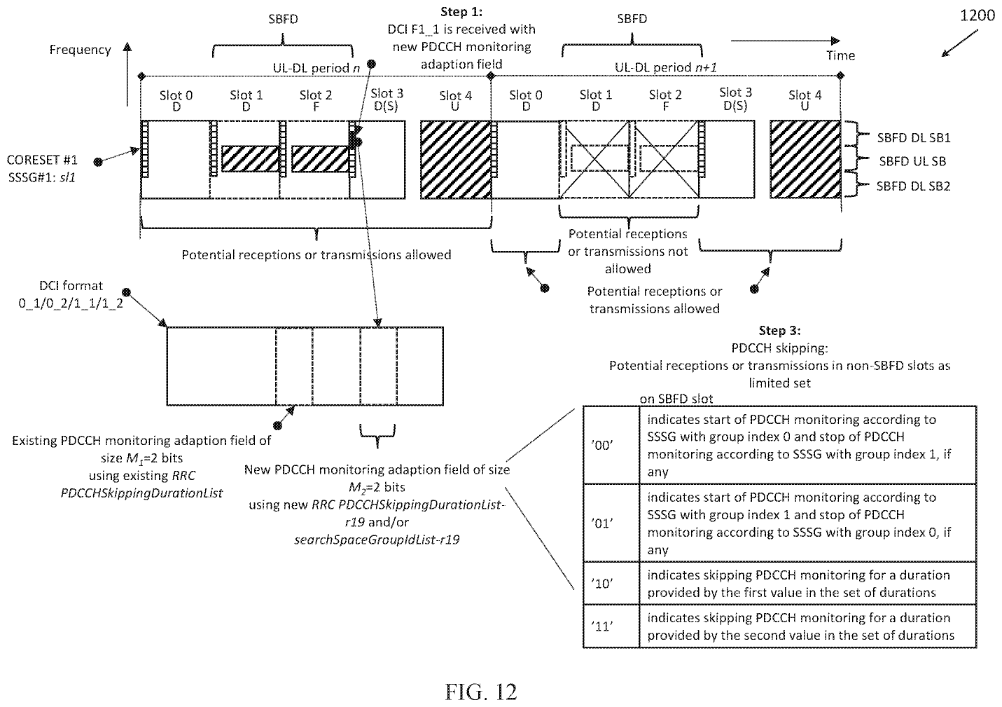

FIG. 12 illustrates a timeline 1200 of a DCI indication for PDCCH monitoring adaptation according to embodiments of the present disclosure. For example, timeline 1200 of a DCI indication for PDCCH monitoring adaptation can be scheduled by the BS 102 of FIG. 1. This example is for illustration only and other embodiments can be used without departing from the scope of the present disclosure.

In one embodiment, a UE may be provided both PDCCHSkippingDurationList-r19 for PDCCH monitoring adaptation and searchSpaceGroupIdList-r19 for SSSG adaptation. As described for PDCCH skipping or SSSG switching operation, an indication value may be provided to the UE 116 by a unicast DCI such as DCI format 0_1/0_2/1_1/1_2, using an existing PDCCH monitoring adaptation field, or an extended PDCCH monitoring adaptation field that includes additional bits in case of full-duplex/SBFD operation, or an existing and a new PDCCH monitoring field to indicate PDCCH monitoring adaptation in slot/symbols or subbands where full-duplex operation is supported, or to indicate PDCCH monitoring adaptation in slot/symbols or subbands where full-duplex operation is not supported. A group-common DCI format, such as a DCI format 2_0 or 4_0 as described in REF2, can also be used to provide an indication value to the UE 116 for PDCCH monitoring adaptation.

For example, an indication value associated with a PDCCH monitoring adaptation may be provided to the UE 116 by DCI using an existing PDCCH monitoring adaptation field with size of 1 or 2 bits, or an extended field with size of 2 or 4 bits, or both an existing and a new field with jointly or separately configured sizes, where a size of 0 bits represents the case that the field is not configured by the gNB 102 for the UE 116, and using PDCCHSkippingDurationList-r19 or searchSpaceGroupIdList-r19.

When a UE is provided both PDCCHSkippingDurationList-r19 and searchSpaceGroupIdList-r19, a mapping of a PDCCH monitoring adaptation field can be such that some values indicate a duration for PDCCH skipping and some values indicate a new SSSG. As for only PDCCH skipping or only SSSG switching, the UE 116 may also be provided existing PDCCHSkippingDurationList and searchSpaceGroupIdList. In such case, PDCCH skipping or SSSG switching can be separately indicated for non-SBFD slots or symbols or subbands by a value of a first field in the DCI format indicating an entry from PDCCHSkippingDurationList, or from searchSpaceGroupIdList for SBFD slots or symbols or subbands and by a value of a second field in the DCI format indicating an entry from PDCCHSkippingDurationList-r19, or from searchSpaceGroupIdList-r19, or depending on a type of slot/symbols where the UE 116 receives the PDCCH providing the DCI format. The first and second fields can be same or different.

In case the first and second fields in a DCI are a same field and in a first approach, a same value can apply to determine an entry from PDCCHSkippingDurationList or searchSpaceGroupIdList, or from PDCCHSkippingDurationList-r19 or searchSpaceGroupIdList-r19 in case these parameters are applicable to all symbol/slot/subband types, that is applicable to non-SBFD slots or symbols or subbands, and an entry from PDCCHSkippingDurationList-r19 or searchSpaceGroupIdList-r19 that is applicable to SBFD slots or symbols or subbands. Alternatively, the value may be applicable only to slots/symbols of same type as the slot/symbols of the PDCCH reception with the DCI.

In case the first and second fields are a same field and in a second approach, first bits of the field provide a first value to determine an entry from PDCCHSkippingDurationList or searchSpaceGroupIdList, or from PDCCHSkippingDurationList-r19 or searchSpaceGroupIdList-r19 in case these parameters are applicable to all symbol/slot/subband types, that is applicable to non-SBFD slots or symbols or subbands and second bits from the field provide a second value to determine an entry from PDCCHSkippingDurationList-r19 or searchSpaceGroupIdList-r19 that is applicable to SBFD slots or symbols or subbands.

In case the first and second fields are different, a first value of the first field indicates an entry from PDCCHSkippingDurationList or searchSpaceGroupIdList, or from PDCCHSkippingDurationList-r19 or searchSpaceGroupIdList-r19 in case these parameters are applicable to all symbol/slot/subband types, that is applicable to non-SBFD slots or symbols or subbands and a second value of the second field indicates an entry from PDCCHSkippingDurationList-r19 or searchSpaceGroupIdList-r19 that is applicable to SBFD slots or symbols or subbands.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to receive physical downlink control channels (PDCCHs), the method comprising:
receiving a first set of parameters for reception of first PDCCHs associated with a first subset of slots from a set of slots on a cell;
receiving a second set of parameters for reception of second PDCCHs associated with a second subset of slots from the set of slots on the cell;
receiving a first PDCCH from the first PDCCHs that provides a downlink control information (DCI) format, wherein the DCI format includes a field indicating skipping receptions of the second PDCCHs; and
skipping, based on the field, receptions of the second PDCCHs in a slot from the second subset of slots at a first occasion that is after reception of the first PDCCH and before an end of a time duration,
wherein the first subset of slots does not include time-domain resources indicated for simultaneous transmission and reception on the cell, and
wherein the second subset of slots includes time-domain resources indicated for simultaneous transmission and reception on the cell.

2. The method of claim 1, wherein:
the field indicates the time duration associated with the skipping of receptions of the second PDCCHs, and
the second PDCCHs are associated with a UE-specific or a common search space set for the time duration.

3. The method of claim 2, wherein:
the field comprises of first bits and second bits,
the first bits indicate time duration associated with skipping of receptions of the first PDCCHs, and
the second bits indicate time duration associated with skipping of receptions of the second PDCCHs.

4. The method of claim 1, further comprising receiving the second PDCCHs in a slot from the second subset of slots at a second occasion that is after the end of the time duration.

5. The method of claim 4, wherein:
skipping receptions of the second PDCCHs further comprises skipping receptions based on a slot or symbol type; and
the slot or symbol type is a downlink (DL) or a flexible (F) slot or symbol.

6. The method of claim 5, wherein:
the field corresponds to an extended PDCCH monitoring adaptation field,
the time duration associated with the skipping of receptions of the second PDCCHs is provided by a first radio resource control (RRC) parameter, and
another time duration associated with skipping of receptions of the first PDCCHs is provided by a second RRC parameter.

7. The method of claim 1, wherein:
skipping receptions of the second PDCCHs further comprises skipping receptions based on a subband full-duplex (SBFD) subband type; and
the SBFD subband type is a first DL subband, a second DL subband, a flexible (F) subband, or an uplink (UL) subband.

8. A user equipment (UE), comprising:
a processor; and
a transceiver operably coupled to the processor, the transceiver configured to:
receive a first set of parameters for reception of first physical downlink control channels (PDCCHs) associated with a first subset of slots from a set of slots on a cell;
receive a second set of parameters for reception of second PDCCHs associated with a second subset of slots from the set of slots on the cell;
receive a first PDCCH from the first PDCCHs that provides a downlink control information (DCI) format, wherein the DCI format includes a field indicating skipping receptions of the second PDCCHs; and
skip, based on the field, receptions of the second PDCCHs in a slot from the second subset of slots at a first occasion that is after reception of the first PDCCH and before an end of a time duration,
wherein the first subset of slots does not include time-domain resources indicated for simultaneous transmission and reception on the cell, and
wherein the second subset of slots includes time-domain resources indicated for simultaneous transmission and reception on the cell.

9. The UE of claim 8, wherein:
the field indicates the time duration associated with the skipping of receptions of the second PDCCHs, and
the second PDCCHs are associated with a UE-specific or a common search space set for the time duration.

10. The UE of claim 9, wherein:
the field comprises of first bits and second bits,
the first bits indicate time duration associated with skipping of receptions of the first PDCCHs, and
the second bits indicate time duration associated with skipping of receptions of the second PDCCHs.

11. The UE of claim 8, the transceiver is further configured to receive the second PDCCHs in a slot from the second subset of slots at a second occasion that is after the end of the time duration.

12. The UE of claim 11, wherein:
the transceiver is further configured to skip receptions of the second PDCCHs based on a slot or symbol type; and
the slot or symbol type is a downlink (DL) or a flexible (F) slot or symbol.

13. The UE of claim 12, wherein:
the field corresponds to an extended PDCCH monitoring adaptation field,
the time duration associated with the skipping of receptions of the second PDCCHs is provided by a first radio resource control (RRC) parameter, and
another time duration associated with skipping of receptions of the first PDCCHs is provided by a second RRC parameter.

14. The method of claim 1, wherein:
the transceiver is further configured to skip receptions of the second PDCCHs based on a subband full-duplex (SBFD) subband type; and
the SBFD subband type is a first DL subband, a second DL subband, a flexible (F) subband, or an uplink (UL) subband.

15. A base station (BS), comprising:
a processor; and
a transceiver operably coupled to the processor, the transceiver configured to:
transmit a first set of parameters for reception of first physical downlink control channels (PDCCHs) associated with a first subset of slots from a set of slots on a cell;
transmit a second set of parameters for reception of second PDCCHs associated with a second subset of slots from the set of slots on the cell;
transmit a first PDCCH from the first PDCCHs that provides a downlink control information (DCI) format; and
transmit the second PDCCHs in a slot from the second subset of slots at a first occasion, receptions of which is skipped, that is after transmission of the first PDCCH and before an end of the time duration;
wherein the first subset of slots does not include time-domain resources indicated for simultaneous transmission and reception on the cell, and
wherein the second subset of slots includes time-domain resources indicated for simultaneous transmission and reception on the cell.

16. The BS of claim 15, wherein:
the field indicates the time duration associated with the skipping of receptions of the second PDCCHs, and
the second PDCCHs are associated with a user equipment (U)E-specific or a common search space set for the time duration.

17. The BS of claim 16, wherein:
the field comprises of first bits and second bits,
the first bits indicate time duration associated with skipping of receptions of the first PDCCHs, and
the second bits indicate time duration associated with skipping of receptions of the second PDCCHs.

18. The BS of claim 15, the transceiver is further configured to transmit the second PDCCHs in a slot from the second subset of slots at a second occasion that is after the end of the time duration.

19. The BS of claim 18, wherein:
the transceiver is further configured to transmit the second PDCCHs based on a slot or symbol type receptions of which are skipped; and
the slot or symbol type is a downlink (DL) or a flexible (F) slot or symbol.

20. The UE of claim 19, wherein:
the field corresponds to an extended PDCCH monitoring adaptation field,
the time duration associated with skipping of receptions of the second PDCCHs is provided by a first radio resource control (RRC) parameter, and
another time duration associated with skipping of receptions of the first PDCCHs is provided by a second RRC parameter.
